(19) United States
(12) Patent Application Publication
(10) Pub. No.: US 2014/0090680 A1
(43) Pub. Date: Apr. 3, 2014

(54) Canopy System for an Emergency Gurney

(71) Applicant: Leilani REIS, Chula Vista, CA (US)

(72) Inventor: Leilani REIS, Chula Vista, CA (US)

(21) Appl. No.: 14/032,933

(22) Filed: Sep. 20, 2013

Related U.S. Application Data
(60) Provisional application No. 61/708,715, filed on Oct. 2, 2012.

(51) Int. Cl. A61G 1/04

(52) U.S. Cl. CPC A61G 1/04
USPC 135/96

(57) ABSTRACT

The canopy system for an emergency gurney includes a gurney and a canopy, where the canopy is attached to the gurney by a left and right attachment mechanism so that the patient facial area can be covered with the canopy. The canopy can be adjustably positioned in a fully stowed position and a fully deployed position through a pivoting mechanism of the canopy system for an emergency gurney. The pivoting mechanism enables the canopy to move in between the fully stowed position and the fully deployed position so that the emergency personals are able to attend the patient while protecting the patient from the inclement weather and/or the hostile environmental conditions.

The current application claims a priority to the U.S. Provisional Patent application Ser. No. 61/708,715 filed on Oct. 2, 2012.

### FIELD OF THE INVENTION

The present invention relates generally to the field of emergency gurneys. More specifically the present invention is a canopy system for an emergency gurney which shields the patient from inclement weather and harsh conditions.

### BACKGROUND OF THE INVENTION

Whenever an ambulance responds to an emergency situation, there is a significant chance that an emergency gurney will be used to transport a patient away from the initial area or accident site. Emergency gurneys are used to transport the patient to the ambulance and then subsequently transport that patient from the ambulance into the hospital upon the arrival of the ambulance at the hospital. Often times the patient must be transported to the ambulance through inclement weather and or hostile environmental conditions such as harsh sunlight. Such conditions can put an incredible amount of unnecessary stress on a human body that is already struggling for survival. Adding to the stress is the fact that sometimes the patient is transported from the comfort of their home out into the inclement weather and or harsh environmental conditions. Such a transition only adds more stress on the patient and can significantly weaken the patient's immune system or cause certain conditions to intensify and worsen, thus putting the patient's life in danger. Many emergency paramedics can attest to the fact that such environmental conditions and shocking transitions can be dangerous to the patient and the only really solution to this problem is to hold a blanket over the patient. Of course, holding a blanket up over the patients head requires the use of a hand which would normally be used to provide additionally stabilization to the emergency gurney which may be translating over perilous terrain. Using only one hand to push and maneuver the gurney can increase the risk of the gurney overturning with patient on board. Such an incident is extremely undesirable and dangerous to the patient who may suffer serious injuries such as broken bones. There is a need in the art for a device which shields a gurney bound patient from inclement weather and harsh conditions while allowing the emergency paramedic to maintain visual observation of the patient as well as keeping both hands on the gurney to minimize chances of the gurney rolling over.

Resultantly, it is an object of the present invention to provide a device that is capable of shielding the patient from inclement weather and harsh conditions while still allowing the emergency paramedic to maintain visual observation of the patient and to keep both hands on the gurney while the gurney is in transit. Another issue that can be solved by the present invention is the issue of privacy. Some people may not wish to be seen while being transported from their homes or an accident site by emergency personnel. For example high profile patients such as celebrities, politicians, or people who simply wish to maintain their privacy during a potentially embarrassing incident. It is therefore an object of the present invention to provide privacy to the patient by blocking the view of outside observers while still allowing the emergency paramedic to have quick access to the patient.

### BRIEF DESCRIPTION OF THE DRAWINGS

FIG. 1 is a front perspective view of the first embodiment of the present invention, showing the canopy is in the fully deployed position and the gurney is in the laying position.

FIG. 2 is a side view of the first embodiment of the present invention, showing the canopy is in the fully deployed position and the gurney is in the laying position.

FIG. 3 is a back perspective view of the first embodiment of the present invention, showing the canopy is in the fully deployed position and the gurney is in the laying position.

FIG. 4 is a back perspective view of the first embodiment of the present invention, showing the canopy is in the partially deployed position and the gurney is in the laying position.

FIG. 5 is a back perspective view of the first embodiment of the present invention, showing the canopy is in the fully stowed position and the gurney is in the laying position.

FIG. 6 is a perspective view of the canopy in the fully deployed position.

FIG. 7 is a perspective view of the left attachment mechanism and the right attachment mechanism.

FIG. 8 is an exploded view of the left and right attachment mechanism of the preferred embodiment of the first embodiment.

FIG. 9 is a front perspective view of the first embodiment of the present invention, showing the canopy is in the fully deployed position and the gurney is in the sitting position.

FIG. 10 is a back perspective view of the first embodiment of the present invention, showing the canopy is in the fully deployed position and the gurney is in the sitting position.

FIG. 11 is a back perspective view of the first embodiment of the present invention, showing the canopy is in the partially deployed position and the gurney is in the sitting position.

FIG. 12 is a back perspective view of the first embodiment of the present invention, showing the canopy is in the fully stowed position and the gurney is in the sitting position.

FIG. 13 is a perspective view of the second embodiment of the present invention.

FIG. 14 is a side view of the present invention, showing the fully deployed gurney with respect to the arched axis.

FIG. 15 is a side view of the present invention, showing the partially deployed gurney from the front side with respect to the arched axis.

FIG. 16 is a side view of the present invention, showing the partially deployed gurney from the back side with respect to the arched axis.

FIG. 17 is a side view of the present invention, showing the fully stowed gurney with respect to the arched axis.

### DETAIL DESCRIPTIONS OF THE INVENTION

All illustrations of the drawings are for the purpose of describing selected versions of the present invention and are not intended to limit the scope of the present invention.

The present invention is a canopy 9 system for an emergency gurney that comprises a gurney 1, a left attachment mechanism 5, a right attachment mechanism 6, and a canopy 9. The canopy 9, which functions as a safety barrier and/or a privacy device, is attached to the gurney 1 through the left attachment mechanism 5 and the right attachment mechanism 6 so that the canopy 9 can be positioned in between a fully stowed position and a fully deployed position.

The gurney 1 can be any kind of emergency cot which uses to transport patients from one location to another. For example, the gurney 1 is used to transport the patients to the ambulance and then afterward transported from the ambulance to the hospital.

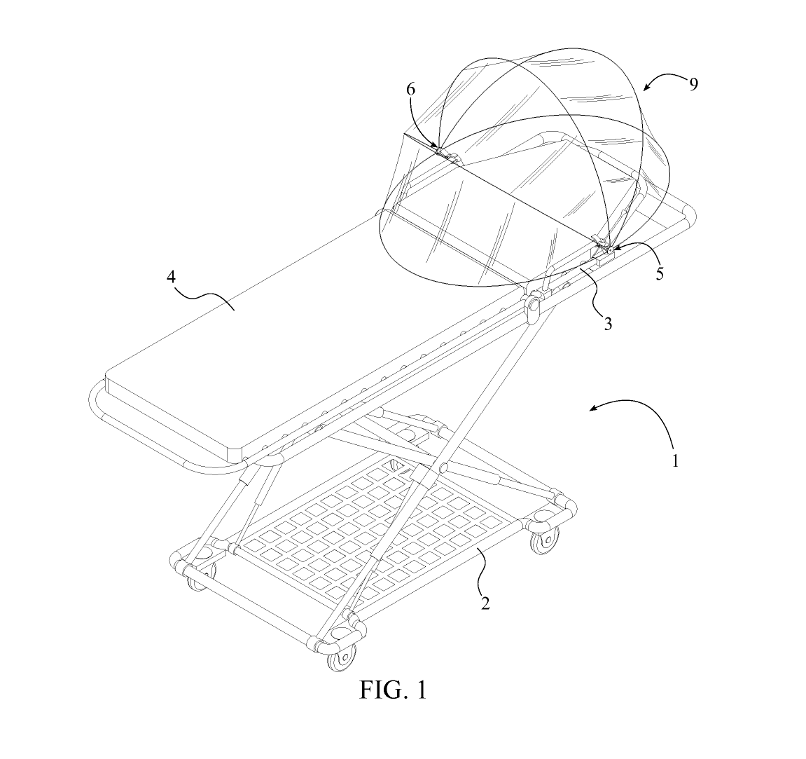

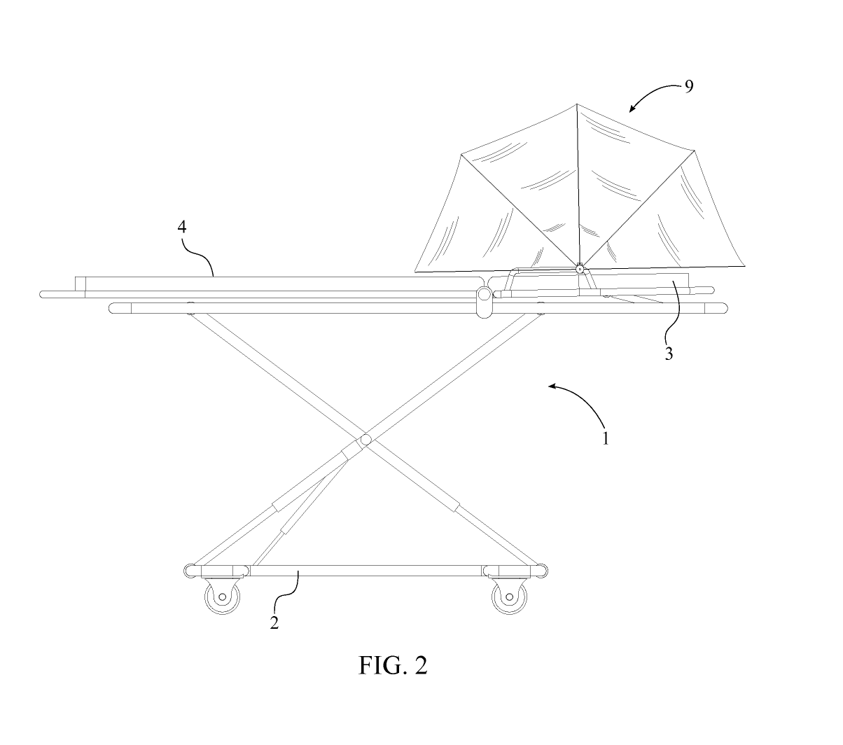

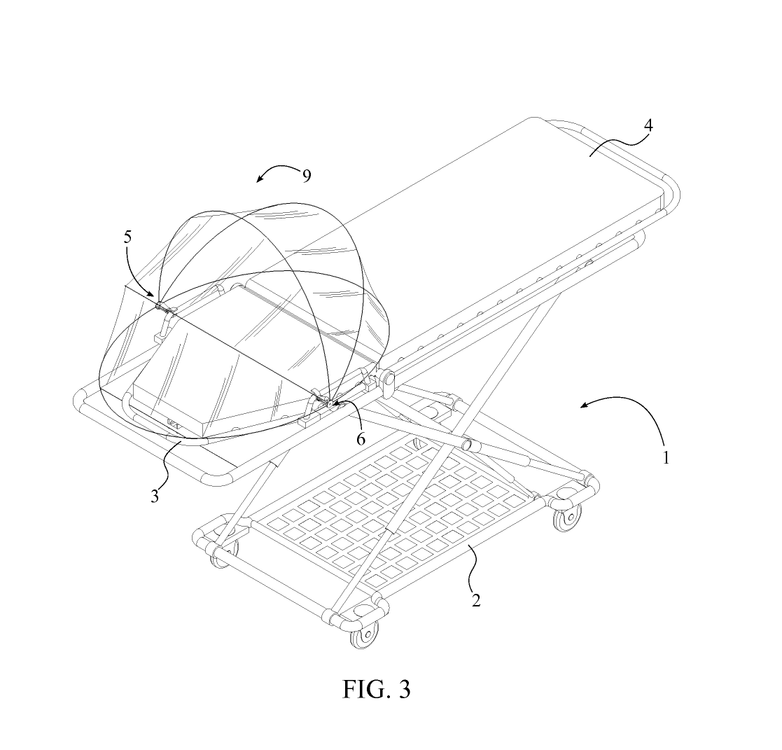

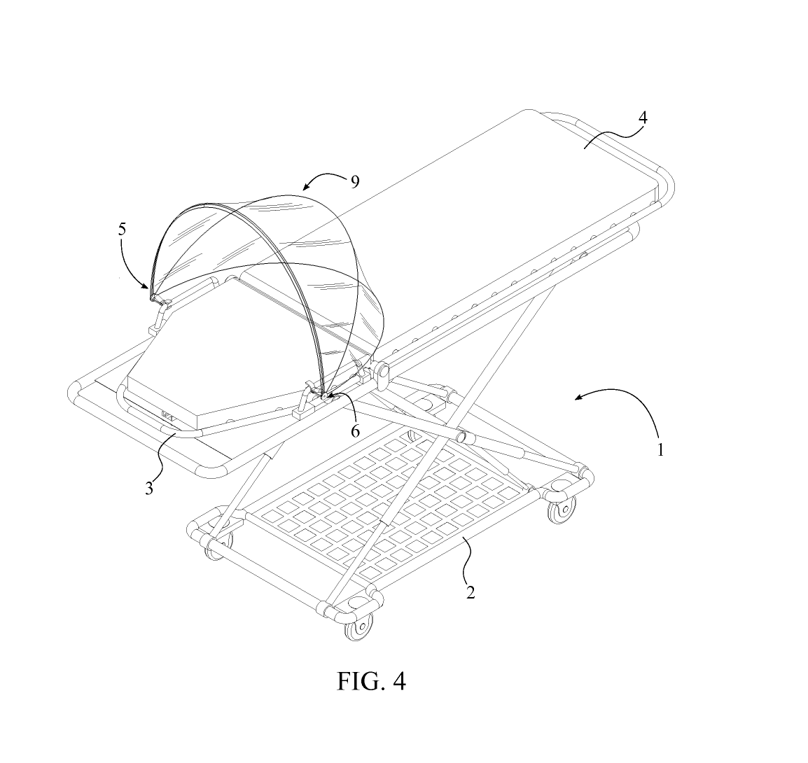

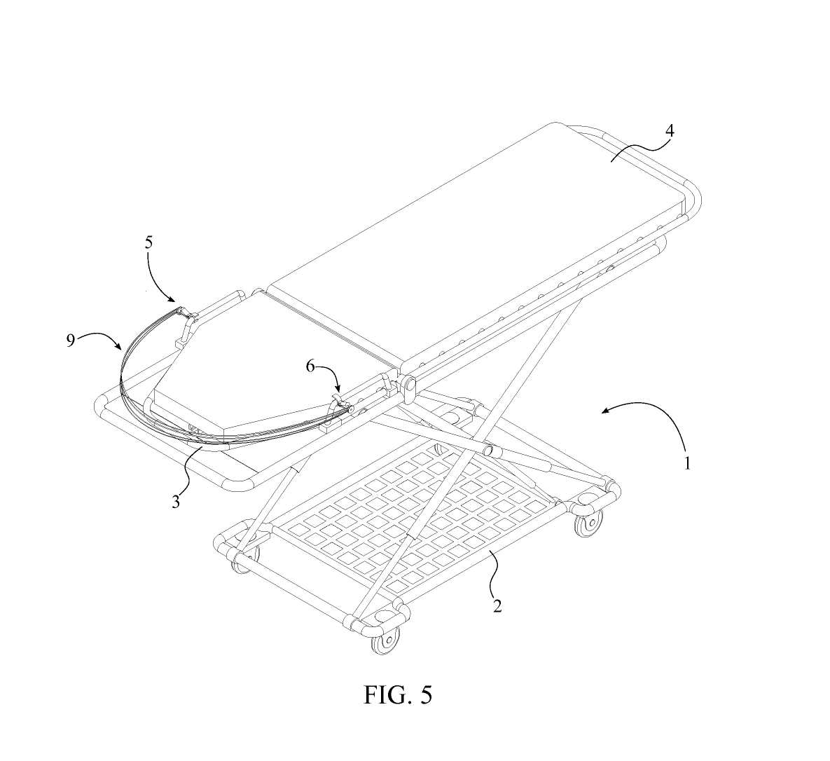

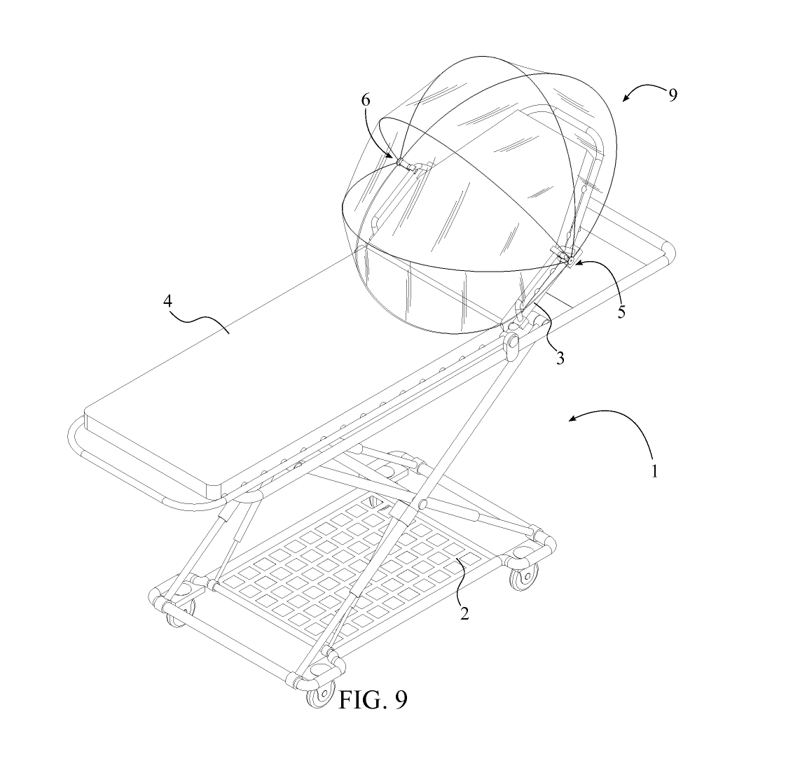

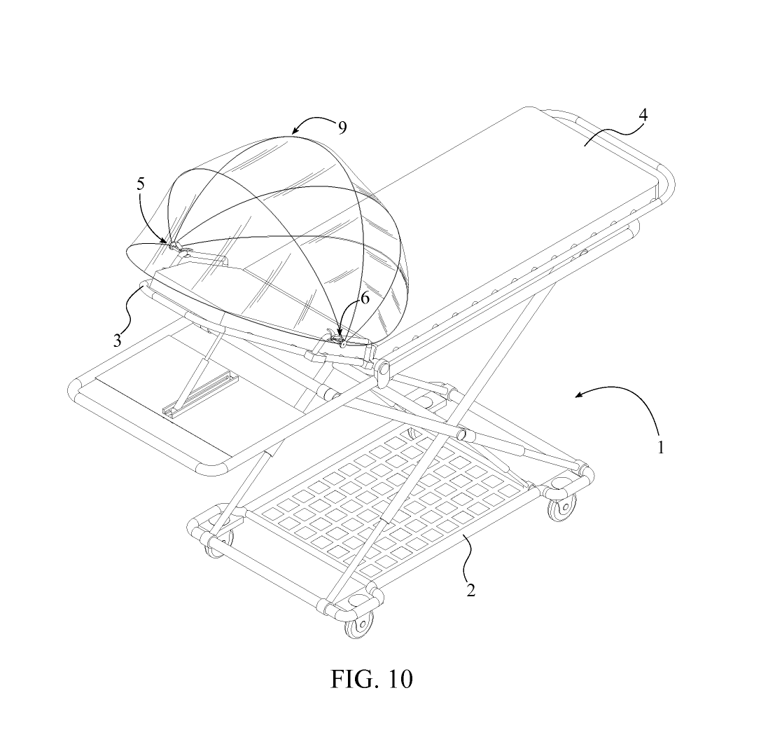

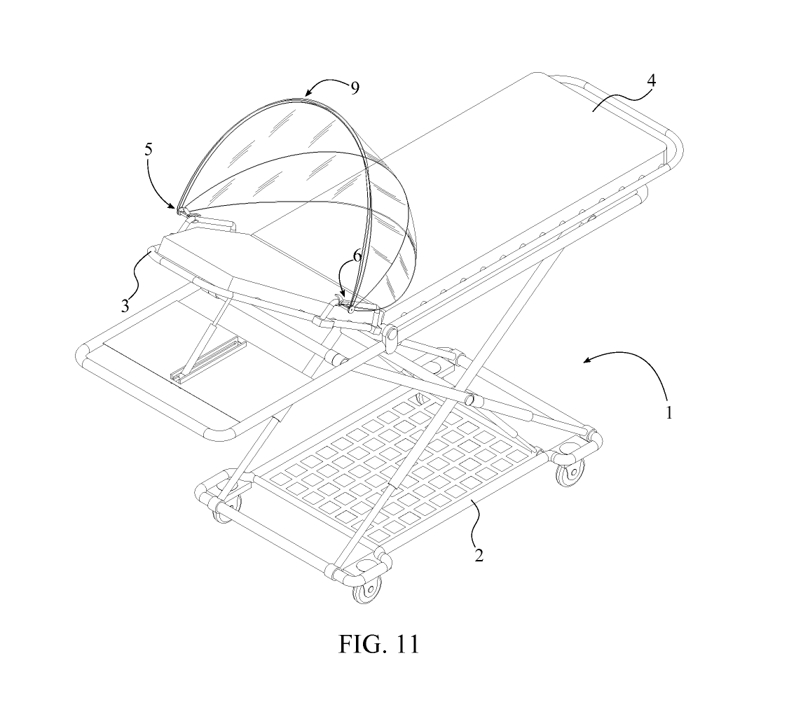

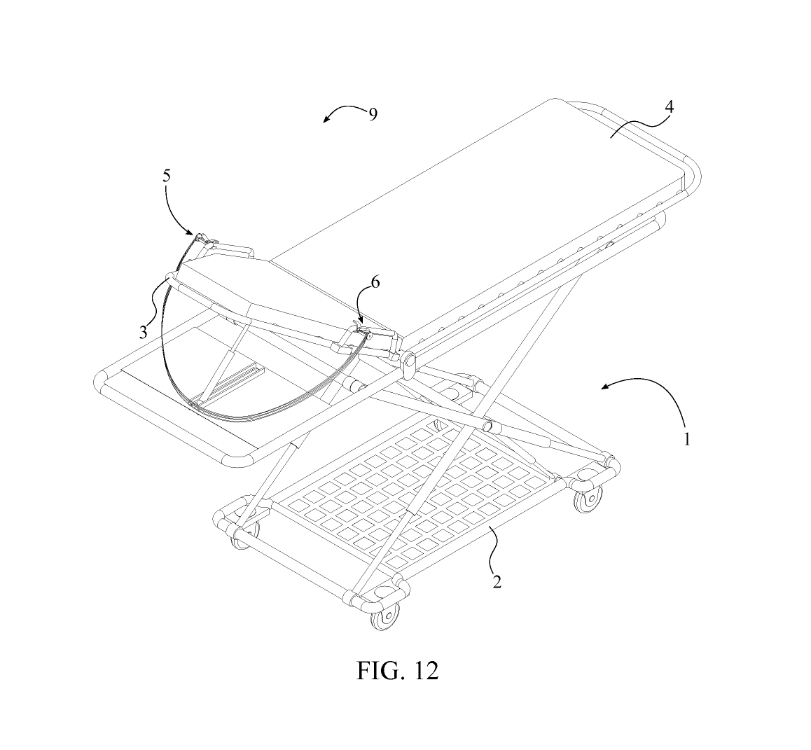

Additionally, the gurney 1 can also use to transport the patients within the hospital. The gurney 1 comprises a base frame 2, an upper body resting bed 3, and a lower body resting bed 4. The upper body resting bed 3 is positioned atop the base frame 2 and adjustably connected with the base frame 2 in such way that the upper body resting bed 3 can be positioned between a laying position and a sitting position. The upper body resting bed 3 supports the upper body portion of the patient when the patient is placed on the gurney 1. The lower body resting bed 4 is positioned atop the base frame 2 and connected with the base frame 2, where the lower body resting bed 4 is oppositely positioned from the upper body resting bed 3. The lower body resting bed 4 supports the lower body portion of the patient when the patient is placed on the gurney 1. In reference to FIG. 1-FIG. 5, when the upper body resting bed 3 is in the laying position, the upper body resting bed 3 and the lower body resting bed 4 are linearly positioned with each other so that the patient can be laid on the gurney 1 face up or face down. In reference to FIG. 9-FIG. 12, when the upper body resting bed 3 is in the sitting position, the upper body resting bed 3 and the lower body resting bed 4 are angularly positioned with each other so that the patient can sit on the gurney 1.

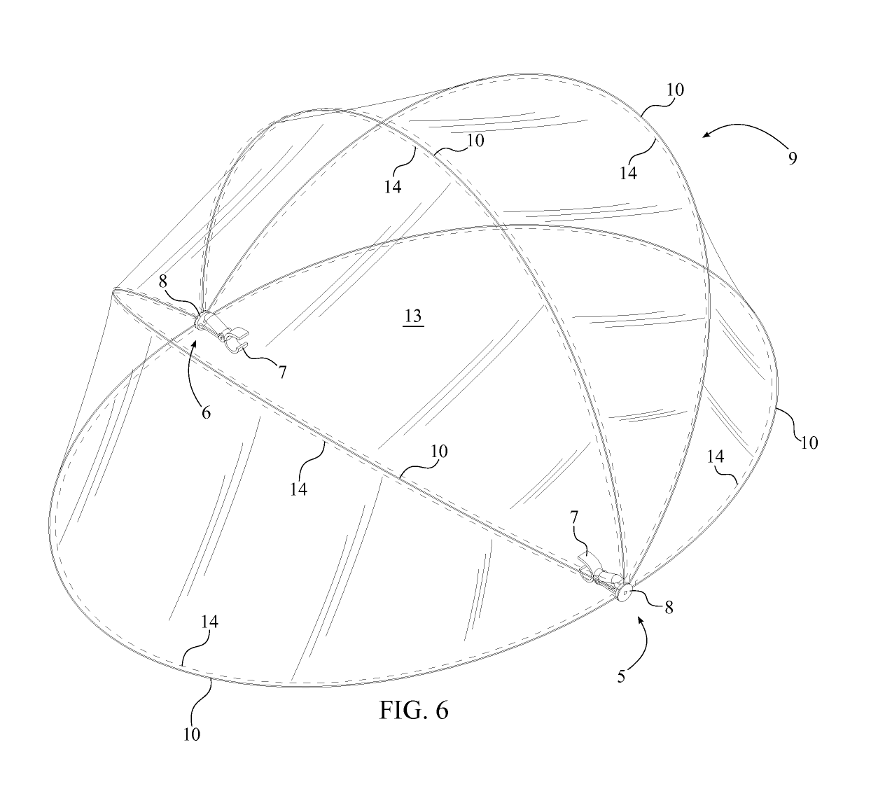

In reference to FIG. 6, the left attachment mechanism 5 and the right attachment mechanism 6 each comprise a gripping mechanism 7 and a pivoting mechanism 8, where the gripping mechanism 7 is linearly connected with the pivoting mechanism 8. The left attachment mechanism 5 and the right attachment mechanism 6 function as the connecting components between the gurney 1 and the canopy 9.

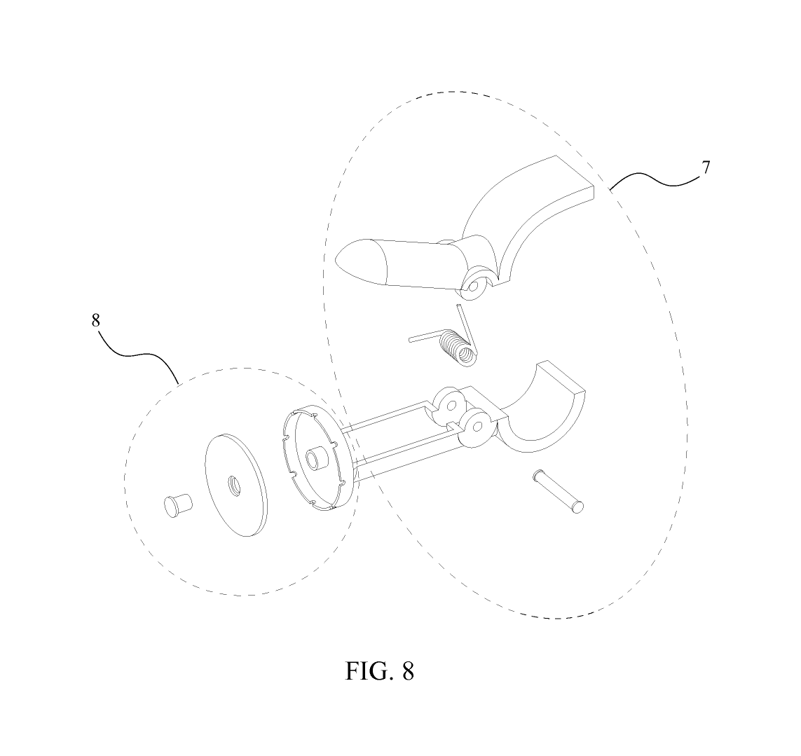

In reference to a first embodiment of the present invention that is shown in FIG. 1-FIG. 12, the gripping mechanism 7 of the left attachment mechanism 5 and the gripping mechanism 7 of the right attachment mechanism 6 are removably attached to the upper body resting bed 3 while the canopy 9 is attached to the left attachment mechanism 5 and the right attachment mechanism 6 through the pivoting mechanisms 8. As for the proper positioning of the canopy 9 within the first embodiment, the gripping mechanism 7 of the left attachment mechanism 5 is oppositely and linearly positioned from the gripping mechanism 7 of the right attachment mechanism 6. Any type gripping mechanism 7 can be used within the first embodiment of present invention as long as the gripping mechanisms 7 of the left attachment mechanism 5 and the right attachment mechanism 6 allow for quick and easy attachment and removal to or from the gurney 1 without the need for tools so that the canopy 9 can be easily attached or detached from the gurney 1. In other words, the canopy 9 of the first embodiment is removably attached onto the gurney 1 through the gripping mechanism 7 and also interchangeable through the pivoting mechanism 8.

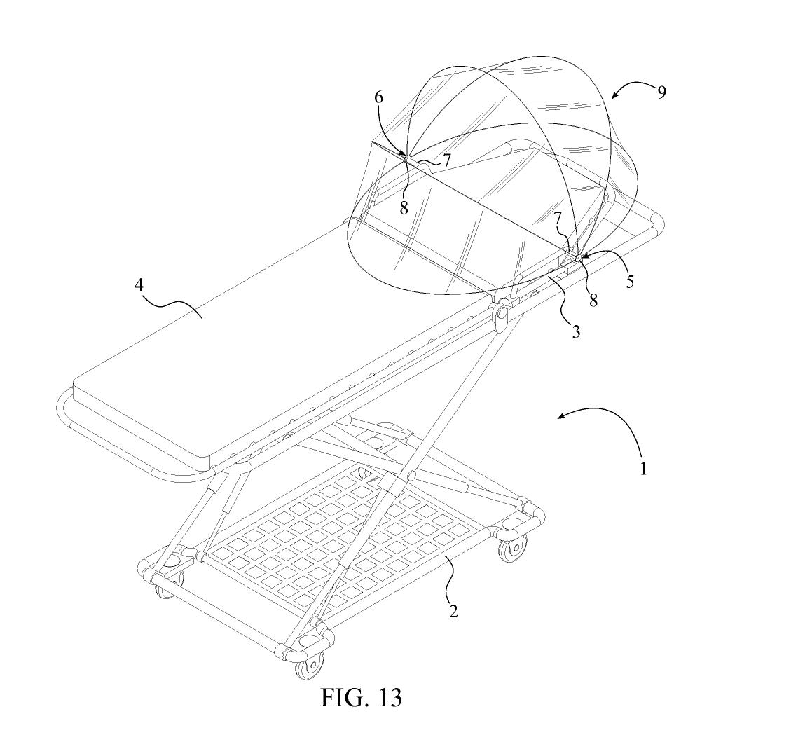

In reference to a second embodiment of the present invention that is shown in FIG. 13, the gripping mechanism 7 of the left attachment mechanism 5 and the gripping mechanism 7 of the right attachment mechanism 6 are permanently connected to the upper body resting bed 3 while the canopy 9 is attached to the left attachment mechanism 5 and the right attachment mechanism 6 through the pivoting mechanisms 8. As for the proper positioning of the canopy 9 within the second embodiment, the gripping mechanism 7 of the left attachment mechanism 5 is oppositely and linearly positioned from the gripping mechanism 7 of the right attachment mechanism 6. The gripping mechanisms 7 for the left attachment mechanism 5 and the right attachment mechanism 6 of the second embodiment are structural protrusions manufactured into the upper body resting bed 3, where the canopy 9 can be easily attached or detached to and from the gurney 1 through the pivoting mechanism 8. In other words, the canopy 9 of the second embodiment is permanently connected into the gurney 1 through the gripping mechanism 7 but interchangeable through the pivoting mechanism 8.

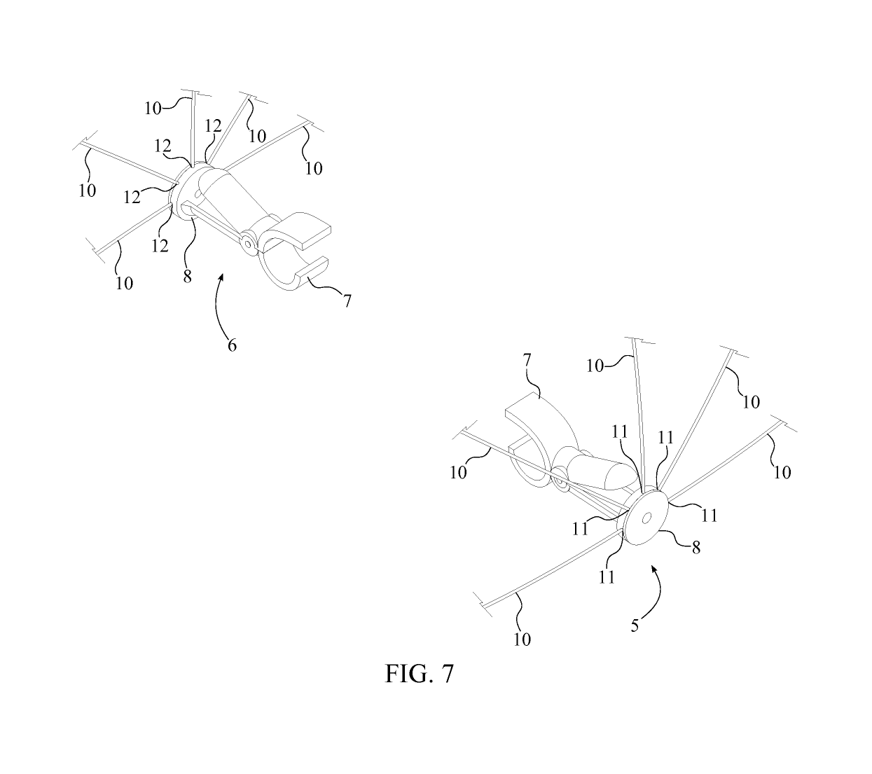

In reference to FIG. 6 and FIG. 7, the canopy 9 comprises a plurality of ribs 10 and a flexible barrier 13, where the plurality of ribs 10 and the flexible barrier 13 define a curvilinear shape to the canopy 9. Each of the plurality of ribs 10, which is a long rod or wire, comprises a left extremity 11 and a right extremity 12, where the left extremity 11 and the right extremity 12 are oppositely positioned from each other along the plurality of ribs 10. The plurality of ribs 10 is bent into a roughly hemispherical or semielliptical shape, and the plurality of ribs 10 can be manufactured out of any rigid material such as metals and plastics. The flexible barrier 13 comprises a plurality of sleeves 14, where the plurality of sleeves 14 is connected onto the flexible barrier 13. The flexible barrier 13 is the component that is responsible for shielding the patient from inclement weather, harsh environmental conditions, or prying eyes. The flexible barrier 13 can be many different colors and levels of opacity. For example, the flexible barrier 13 can be completely clear if it is designed solely to protect the patient from rain whereas the flexible barrier 13 may be slightly opaque in order to help block sunlight from reaching the patient. The barrier can also be entirely opaque such that no light may shine through to the patient, thus providing complete privacy to the patient.

In reference to FIG. 6 and FIG. 7, the plurality of ribs 10 is inserted through the plurality of sleeves 14 in such way that the left extremity 11 and the right extremity 12 are equally extended outward from the plurality of sleeves 14. Even though the plurality of ribs 10 is inserted though the plurality of sleeves 14 in the present invention, the plurality of ribs 10 can be adhered, sewed, or affixed to the flexible barrier 13 in different configurations of the present invention. The left extremities 11 of the plurality of ribs 10 are adjustably attached to the pivoting mechanism 8 of the left attachment mechanism 5, and the right extremities 12 of the plurality of ribs 10 are adjustably attached to the pivoting mechanism 8 of the right attachment mechanism 6. When the plurality of ribs 10 and the flexible barrier 13 are attached to the pivoting mechanism 8 of the left attachment mechanism 5 and the right attachment mechanism 6, the flexible barrier 13 and the plurality of ribs 10 create a tent like structure for the canopy 9, where the flexible material is stretched over and attached to the plurality of ribs 10.

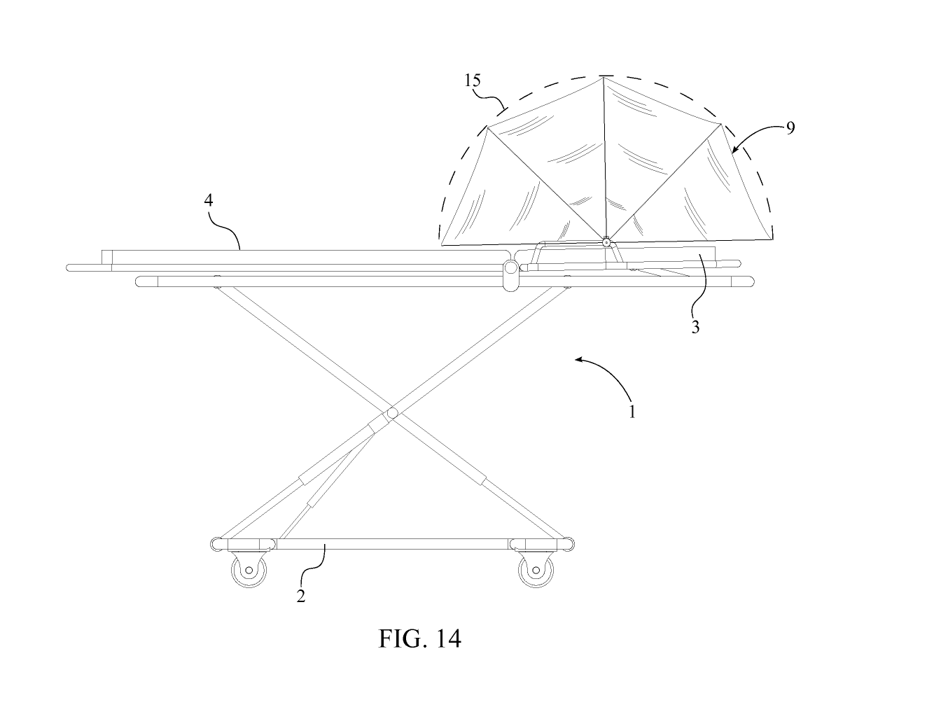

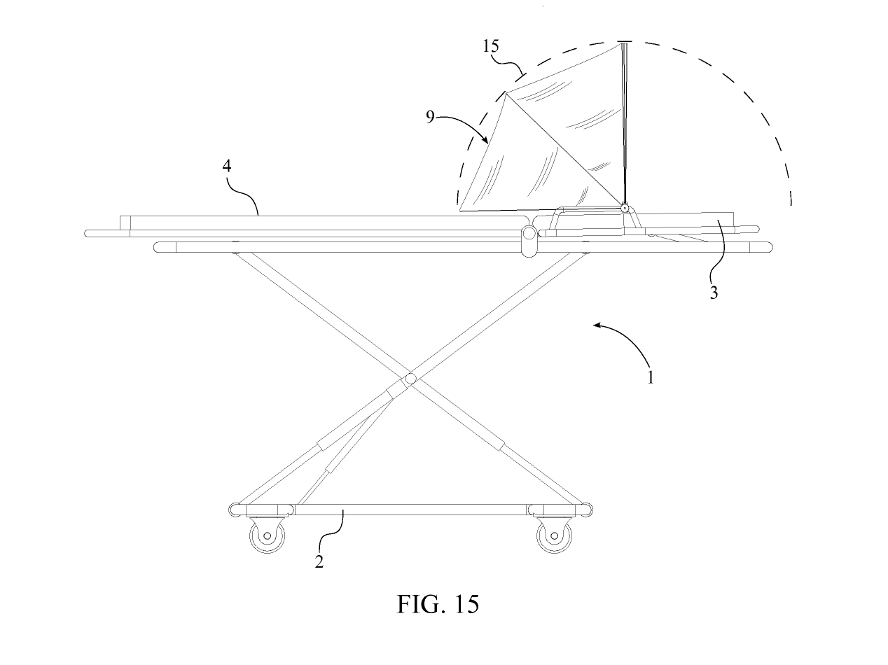

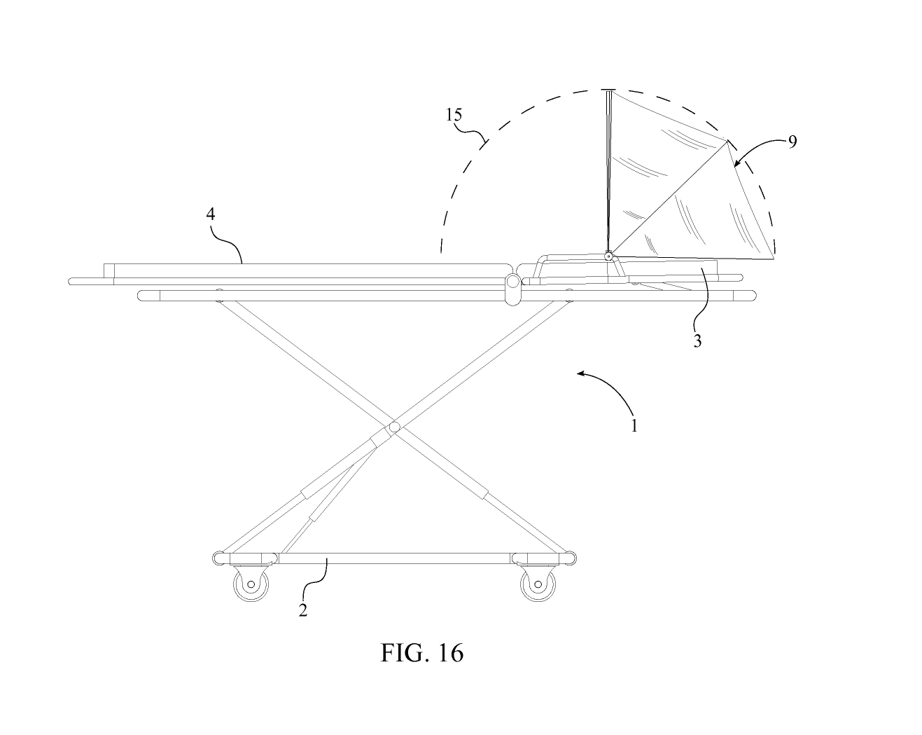

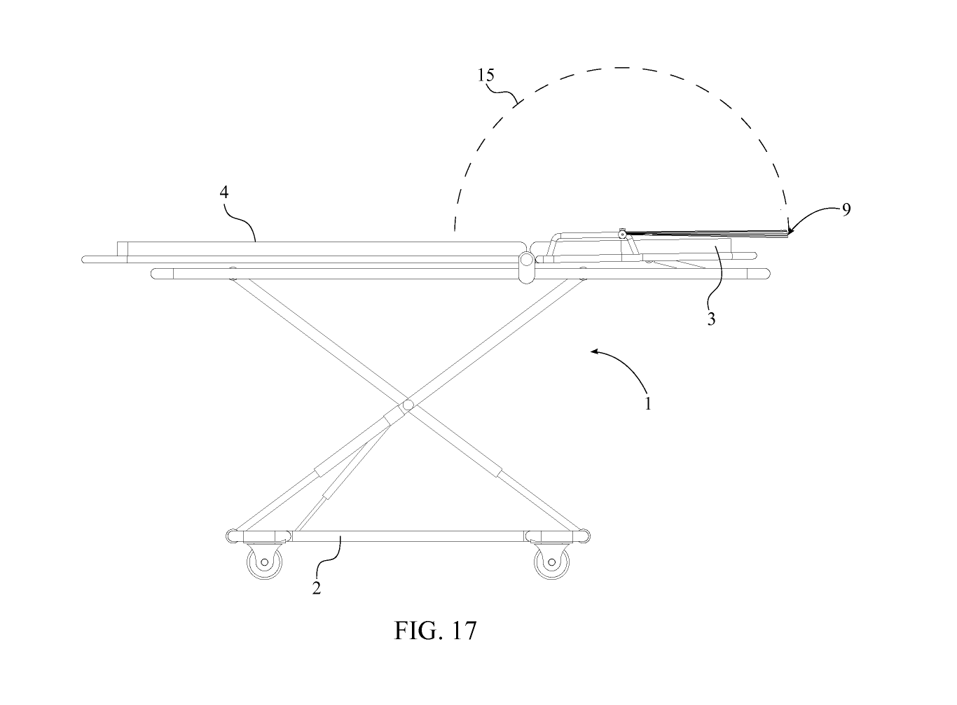

In reference to FIG. 14-FIG. 17, the pivoting mechanism 8 of the present invention allows the canopy 9 to adjustably travel along an arched axis 15 in between the fully stowed position and the fully deployed position, where the pivoting mechanism 8 allows the canopy 9 to extend up to 180 degrees. It is also important to note that pivoting mechanism 8 allows the plurality of ribs 10 and the flexible barrier 13 to move together, thus allowing the canopy 9 to be partially stowed or pulled up for quick access to the patient. The pivoting mechanism 8 also allows the canopy 9 to be fully stowed or pulled away from the patient and rotated down onto the underside of the gurney 1 such that the canopy 9 does not obstruct medical personnel. The pivoting mechanism 8 of the present invention can be any type of pivoting mechanism 8 as long as the canopy 9 can be easily extended and secured along the arched axis 15 with respect to different positions, such as the fully stowed position, the fully deployed position, and partially deployed positions.

It is also contemplated that the flexible barrier 13 and the plurality of ribs 10 of the present invention may be fabricated out of a very cheap bio degradable material such that the flexible barrier 13 and the plurality of ribs 10 may be removed from the pivoting mechanism 8 and thrown out. This allows the canopy 9 of present invention to be removed and replaced with a new one, thus helping to maintain sanitary conditions which are crucial in a medical environment.

In the preferred embodiment of the first embodiment which is shown in FIG. 1-FIG. 12, the gripping mechanism 7 of each of the left attachment mechanism 5 and the right attachment mechanism 6 comprises a top clamp section, a top gripping strip, a top handle section, a bottom clamp section, a bottom gripping strip, a bottom handle section, and a spring loaded hinge. The top clamp section is adjacently positioned with the top handle section, and the top gripping strip is connected with an inside surface of the top clamp section. The bottom clamp section is adjacently positioned with the bottom handle section, and the bottom gripping strip is connected with an inside surface of the bottom clamp section. The spring loaded hinge is positioned in between the top clamp section and the bottom clamp section in such way that the gripping mechanism 7 is completed into a single component. The gripping mechanism 7 normally remains in a closed position and the top handle section positions up and away from the bottom handle section when pressure is not applied through the top handle section. When the pressure is applied to the top handle section, the top handle section is moved downward via the spring loaded hinge, where the top handle section rotates relative to the bottom handle section. Then the gripping mechanism 7 transforms into an opened position, where the opened position allows the users to attach the gripping mechanism 7 with the upper body resting bed 3 through the top clamp section and the bottom clamp section. The pivoting mechanism 8 of the preferred embodiment comprises a base plate, a plurality of notches, and a disk plate. The base plate is adjacently connected with the bottom handle section, connecting the pivoting mechanism 8 to the gripping mechanism 7. The plurality of notches is equally spaced and radially positioned on the base plate so that the left extremity 11 or the right extremity 12 of the plurality of ribs 10 can be secured within the plurality of notches as the disk plate is attached to the base plate via a fastener. The disk plate and the fastener secure the plurality of ribs 10 within the pivoting mechanisms 8 while allowing the canopy 9 to moves along the arched axis 15.

In another embodiment of the present invention, the gripping mechanism 7 of the left attachment mechanism 5 and the right attachment mechanism 6 comprises a locking protrusion, a locking hole, and a locking pin. The locking hole is oppositely positioned from the pivoting mechanism 8 and accepts the locking pin when the locking protrusion is inserted into a locking slot of the upper body resting bed 3. The locking slots are positioned on left and right side of the upper body resting bed so that the both locking protrusions can be accepted in order to properly position the canopy 9. The locking pin secures the locking protrusion with the gurney 1 so that the canopy 9 can be attached through the left attachment mechanism 5 and the right attachment mechanism 6. This allows the canopy 9 to be fully integrated into the gurney 1 while still retaining the easy attachment and removal to and from the emergency gurney 1 through the pivoting mechanism 8.

Although the invention has been explained in relation to its preferred embodiment, it is to be understood that many other possible modifications and variations can be made without departing from the spirit and scope of the invention as hereinafter claimed.

What is claimed is:

1. A canopy system for an emergency gurney comprises:
a gurney;
a left attachment mechanism;
a right attachment mechanism;
a canopy;
the gurney comprises a base frame, an upper body resting bed, and a lower body resting bed;
the left attachment mechanism and the right attachment mechanism each comprise a gripping mechanism and a pivoting mechanism;
the canopy comprises a plurality of ribs and a flexible barrier for defining a curvilinear shape;
each of the plurality of ribs comprises a left extremity and a right extremity; and
the flexible barrier comprises a plurality of sleeves.

2. The canopy system for an emergency gurney as claimed in claim 1 comprises:
the upper body resting bed being adjustably connected with the base frame;
the lower body resting bed being connected with the base frame;
the upper body resting bed and the lower body resting bed being positioned atop the base frame; and
the upper body resting bed being oppositely positioned with the lower body resting bed.

3. The canopy system for an emergency gurney as claimed in claim 1 comprises:
the gripping mechanism being linearly connected with the pivoting mechanism;
the gripping mechanism of the left attachment mechanism being removably attached to the upper body resting bed;
the gripping mechanism of the right attachment mechanism being removably attached to the upper body resting bed; and
the gripping mechanism of the left attachment mechanism being oppositely and linearly positioned from the gripping mechanism of the right attachment mechanism.

4. The canopy system for an emergency gurney as claimed in claim 1 comprises:
the plurality of sleeves being connected with the flexible barrier;
the left extremity and the right extremity being oppositely positioned along the plurality of ribs;
the plurality of ribs being inserted through the plurality of sleeves; and
the left extremity and the right extremity of the plurality of ribs being equally extended outward from the plurality of sleeves.

5. The canopy system for an emergency gurney as claimed in claim 1 comprises:
the left extremity of the plurality of ribs being adjustably attached with the pivoting mechanism of the left attachment mechanism; and
the right extremity of the plurality of ribs being adjustably attached with the pivoting mechanism of the right attachment mechanism.

6. The canopy system for an emergency gurney as claimed in claim 1 comprises:
wherein the pivoting mechanism allows the canopy to be adjustably travels along an arced axis in between a fully stowed position and a fully deployed position.

7. A canopy system for an emergency gurney comprises:
a gurney;
a left attachment mechanism;
a right attachment mechanism;
a canopy;
the gurney comprises a base frame, an upper body resting bed, and a lower body resting bed;
the left attachment mechanism and the right attachment mechanism each comprise a gripping mechanism and a pivoting mechanism;
the canopy comprises a plurality of ribs and a flexible barrier for defining a curvilinear shape;
each of the plurality of ribs comprises a left extremity and a right extremity; and
the flexible barrier comprises a plurality of sleeves.

8. The canopy system for an emergency gurney as claimed in claim 7 comprises:
the upper body resting bed being adjustably connected with the base frame;
the lower body resting bed being connected with the base frame;
the upper body resting bed and the lower body resting bed being positioned atop the base frame; and
the upper body resting bed being oppositely positioned with the lower body resting bed.

9. The canopy system for an emergency gurney as claimed in claim 7 comprises:
the gripping mechanism being linearly connected with the pivoting mechanism;
the gripping mechanism of the left attachment mechanism being connected to the upper body resting bed;
the gripping mechanism of the right attachment mechanism being connected to the upper body resting bed; and
the gripping mechanism of the left attachment mechanism being oppositely and linearly positioned from the gripping mechanism of the right attachment mechanism.

10. The canopy system for an emergency gurney as claimed in claim 7 comprises:
the plurality of sleeves being connected with the flexible barrier;
the left extremity and the right extremity being oppositely positioned along the plurality of ribs;
the plurality of ribs being inserted through the plurality of sleeves; and
the left extremity and the right extremity of the plurality of ribs being equally extended outward from the plurality of sleeves.

11. The canopy system for an emergency gurney as claimed in claim 7 comprises:
the left extremity of the plurality of ribs being adjustably attached with the pivoting mechanism of the left attachment mechanism; and
the right extremity of the plurality of ribs being adjustably attached with the pivoting mechanism of the right attachment mechanism.

12. The canopy system for an emergency gurney as claimed in claim 7 comprises:
wherein the pivoting mechanism allows the canopy to be adjustably travels along an arced axis in between a fully stowed position and a fully deployed position.

13. A canopy system for an emergency gurney comprises:
a gurney;
a left attachment mechanism;
a right attachment mechanism;
a canopy;
the gurney comprises a base frame, an upper body resting bed, and a lower body resting bed;
the left attachment mechanism and the right attachment mechanism each comprise a gripping mechanism and a pivoting mechanism;
the canopy comprises a plurality of ribs and a flexible barrier for defining a curvilinear shape;
each of the plurality of ribs comprises a left extremity and a right extremity;
the flexible barrier comprises a plurality of sleeves;
the upper body resting bed being adjustably connected with the base frame;
the lower body resting bed being connected with the base frame;
the upper body resting bed and the lower body resting bed being positioned atop the base frame; and
the upper body resting bed being oppositely positioned with the lower body resting bed.

14. The canopy system for an emergency gurney as claimed in claim 13 comprises:
the gripping mechanism being linearly connected with the pivoting mechanism;
the gripping mechanism of the left attachment mechanism being removably attached to the upper body resting bed;
the gripping mechanism of the right attachment mechanism being removably attached to the upper body resting bed; and
the gripping mechanism of the left attachment mechanism being oppositely and linearly positioned from the gripping mechanism of the right attachment mechanism.

15. The canopy system for an emergency gurney as claimed in claim 13 comprises:
the plurality of sleeves being connected with the flexible barrier;
the left extremity and the right extremity being oppositely positioned along the plurality of ribs;
the plurality of ribs being inserted through the plurality of sleeves; and
the left extremity and the right extremity of the plurality of ribs being equally extended outward from the plurality of sleeves.

16. The canopy system for an emergency gurney as claimed in claim 13 comprises:
the left extremity of the plurality of ribs being adjustably attached with the pivoting mechanism of the left attachment mechanism; and
the right extremity of the plurality of ribs being adjustably attached with the pivoting mechanism of the right attachment mechanism.

17. The canopy system for an emergency gurney as claimed in claim 13 comprises:
wherein the pivoting mechanism allows the canopy to be adjustably travels along an arced axis in between a fully stowed position and a fully deployed position.
